(19) United States
(12) Patent Application Publication
(10) Pub. No.: US 2020/0285347 A1
(43) Pub. Date: Sep. 10, 2020

(54) TOUCH DISPLAY PANEL, METHOD OF MANUFACTURING THE SAME AND TOUCH DISPLAY DEVICE

(71) Applicant: Yungu (Gu'an) Technology Co., Ltd., Gu'an, Langfang, Hebei (CN)

(72) Inventors: Junyuan MA, Kunshan, Jiangsu (CN); Jiading LIU, Kunshan, Jiangsu (CN); Bing WANG, Kunshan, Jiangsu (CN); Yapeng ZHANG, Kunshan, Jiangsu (CN); Chengming ZHANG, Kunshan, Jiangsu (CN)

(21) Appl. No.: 16/349,122

(22) PCT Filed: Jul. 27, 2018
(86) PCT No.: PCT/CN2018/097341

§ 371 Date: May 10, 2019

(30) Foreign Application Priority Data
Nov. 30, 2017 (CN) 201711241252.3
Nov. 30, 2017 (CN) 201721642852.6

(51) Int. Cl. G06F 3/044

(52) U.S. Cl. CPC G06F 3/0445; G06F 2203/04103; G06F 3/0446

(57) ABSTRACT

A touch display panel, a method of manufacturing the same, and a touch display device are provided by the disclosure. The touch display panel includes: a cathode, an encapsulation layer, and a touch layer. The encapsulation layer is located between the cathode and the touch layer, and the encapsulation layer adopts a material with low dielectric constant.

### FIELD OF THE DISCLOSURE

The disclosure relates to the field of display technology, and in particular to a touch display panel, a method of manufacturing the same, and a touch display device.

### BACKGROUND

A touch display panel integrates a touch screen with a flat display panel to enable a flat display panel with a touch function. Generally, the touch display panel may provide a human-computer interaction interface, and allows an input to be performed by a finger, a stylus, etc., so that its application is more direct and more user-friendly. With the development of display technologies, the touch display panel is increasingly used in various display devices.

With the development of the thinning of the touch display panel, the thickness of the touch display panel gets thinner and thinner. For the display panel and a touch electrode in the touch display panel, the distance between them is coming closer. However, in practical applications, since the distance between the display panel and the touch electrode is relatively closer, when touching the touch display panel, the display panel may interfere with the touch electrode, resulting in the touch electrode having a reduced detection sensitivity and the touch display panel having a damaged or even disabled touch function.

### SUMMARY

The main purpose of the disclosure is to provide a touch display panel, a method of manufacturing the same, and a touch display device, which aim to solve the problem of the effect on the touch sensitivity of the touch electrode in the existing touch display panel, which is caused by great interference with the touch electrode by the display panel due to the closer distance between the display panel and the touch electrode.

To solve the above problem, embodiments of the disclosure provide a touch display panel comprising a cathode, a touch layer and an encapsulation layer located between the cathode and the touch layer, a material of the encapsulation layer having a dielectric constant ranging from 3 to 8.

Optionally, the encapsulation layer has a thickness of 1 to 10 μm.

Optionally, the encapsulation layer comprises at least one of a thin film encapsulation layer and a substrate layer, and when the encapsulation layer comprises the thin film encapsulation layer and/or the substrate layer, a material of at least one of the thin film encapsulation layer and the substrate layer has a dielectric constant ranging from 3 to 8.

Optionally, the touch layer comprises a first electrically conductive layer and a first insulative layer, the first electrically conductive layer comprises a plurality of inductive electrodes and a plurality of drive electrodes, and the first insulative layer covers the first electrically conductive layer and a material of the insulative layer has the dielectric constant equal to or greater than 30.

Optionally, the first insulative layer has a thickness of 0.01 to 10 μm.

Optionally, the touch layer comprises a second electrically conductive layer, a third electrically conductive layer and a second insulative layer, the second electrically conductive layer comprises a plurality of inductive electrodes, and the third electrically conductive layer comprises a plurality of drive electrodes; the second insulative layer is located between the second electrically conductive layer and the third electrically conductive layer and a material of the second electrically conductive layer has the dielectric constant equal to or greater than 30.

Optionally, the second insulative layer has a thickness of 0.01 to 10 μm.

Optionally, the touch display panel further comprises a display panel, wherein the touch layer covers the display panel, and the third electrically conductive layer is located between the second electrically conductive layer and the display panel; an orthographic projection area of the plurality of inductive electrodes on the display panel falls into an orthographic projection area of the plurality of drive electrodes on the display panel.

Optionally, wherein each of the drive electrodes comprises a plurality of sequentially connected drive sub-electrodes, and each of the inductive electrodes comprises a plurality of sequentially connected inductive sub-electrodes, the number of the inductive sub-electrodes is equal to the number of the drive sub-electrodes, and an orthographic projection area of each of the inductive sub-electrodes on the display panel falls into an orthographic projection area of one of the drive sub-electrodes on the display panel, respectively; or the number of the inductive sub-electrodes is greater than the number of the drive sub-electrodes, and an orthographic projection area of at least one inductive sub-electrode on the display panel falls into an orthographic projection area of one of the drive sub-electrodes on the display panel.

Optionally, the third electrically conductive layer further comprises a plurality of filling blocks, the plurality of filling blocks fill a gap between the plurality of drive electrodes; the plurality of filling blocks are insulated from each other, and the plurality of filling blocks and the plurality of drive electrodes are insulated from each other.

The above at least one technical solution adopted by the embodiment of the disclosure can achieve the following beneficial effects:

A touch display panel provided by the disclosure includes a cathode, an encapsulation layer, and a touch layer, and the encapsulation layer is located between the cathode and the touch layer, and the encapsulation layer adopts a material with low dielectric constant. In this way, the encapsulation layer in the touch display panel adopting the material with low dielectric constant may reduce the inductive capacitance between the cathode and the touch electrode in the touch layer. When touching the touch display panel, owing to the reduced inductive capacitance between the cathode and the touch electrode, compared with the prior art, the interference with the touch electrode by the cathode may be alleviated, thereby reducing the damage to the touch function of the touch display panel and improving the touch sensitivity of the touch display panel.

To solve the above problem, embodiments of the disclosure further provide a touch display panel, comprising a first electrically conductive layer, a second electrically conductive layer, and a display panel,

the first electrically conductive layer comprising a plurality of inductive electrodes, and the second electrically conductive layer comprising a plurality of drive electrodes and being located between the first electrically conductive layer and the display panel;

an orthographic projection area of the plurality of inductive electrodes on the display panel falling into an orthographic projection area of the plurality of drive electrodes on the display panel.

Optionally, each of the drive electrodes comprises a plurality of sequentially connected drive sub-electrodes, and each of the inductive electrodes comprises a plurality of sequentially connected inductive sub-electrodes, the number of the inductive sub-electrodes is equal to the number of the drive sub-electrodes, and an orthographic projection area of each of the inductive sub-electrodes on the display panel falls into an orthographic projection area of one of the drive sub-electrodes on the display panel, respectively; or the number of the inductive sub-electrodes is greater than the number of the drive sub-electrodes, and an orthographic projection area of at least one inductive sub-electrode on the display panel falls into an orthographic projection area of one of the drive sub-electrodes on the display panel.

Optionally, the drive sub-electrode has a diamond shape and/or a strip shape, and the inductive sub-electrode has a diamond shape and/or a strip shape.

Optionally, the second electrically conductive layer further comprises a plurality of filling blocks, the plurality of filling blocks fill a gap between the plurality of drive electrodes; the plurality of filling blocks are insulated from each other, and the plurality of filling blocks and the plurality of drive electrodes are insulated from each other.

Optionally, the display panel comprises a drive signal line for providing drive signals comprising at least one of a data voltage signal, a supply power signal, a scan control signal, and a luminescence control signal.

Optionally, the touch display panel comprises a cathode, the cathode comprises at least one hollow-out area, and the position of each hollow-out area corresponds to the position of one of the inductive electrodes or one of the drive electrodes, respectively.

Embodiments of the disclosure further provide a manufacturing method for a touch display panel, comprising:

forming an encapsulation layer on the display panel;

forming a second electrically conductive layer on the encapsulation layer, and etching the second electrically conductive layer to form a plurality of drive electrodes;

evaporating an insulative layer on the second electrically conductive layer;

forming a first electrically conductive layer on the insulative layer, and etching the first electrically conductive layer to form a plurality of inductive electrodes;

making an orthographic projection area of the plurality of inductive electrodes on the display panel fall into an orthographic projection area of the plurality of drive electrodes on the display panel.

Optionally, each of the drive electrodes comprises a plurality of sequentially connected drive sub-electrodes, and each of the inductive electrodes comprises a plurality of sequentially connected inductive sub-electrodes, the number of the inductive sub-electrodes is equal to the number of the drive sub-electrodes, and an orthographic projection area of the inductive sub-electrodes on the display panel falls into an orthographic projection area of one of the drive sub-electrodes on the display panel, respectively; or the number of the inductive sub-electrodes is greater than the number of the drive sub-electrodes, and an orthographic projection area of at least one inductive sub-electrodes on the display panel falls into an orthographic projection area of one of the drive sub-electrodes on the display panel.

Optionally, a plurality of filling blocks are formed when etching the second electrically conductive layer; the plurality of filling blocks fill a gap between the plurality of drive electrodes; the plurality of filling blocks are insulated from each other and the plurality of filling blocks and the plurality of drive electrodes are insulated from each other.

The above at least one technical solution adopted by the embodiment of the disclosure can achieve the following beneficial effects:

A touch display panel provided by the disclosure includes a first electrically conductive layer, a second electrically conductive layer, and a display panel, and the first electrically conductive layer comprises a plurality of inductive electrodes, and the second electrically conductive layer comprises a plurality of drive electrodes and is located between the first electrically conductive layer and the display panel; an orthographic projection area of the plurality of inductive electrodes on the display panel falling into an orthographic projection area of the plurality of drive electrodes on the display panel. In this way, since the drive electrode is located between the inductive electrode and the display panel and an orthographic projection area of the inductive electrode on the display panel falls into an orthographic projection area of the drive electrode on the display panel, the drive electrode can effectively obstruct or absorb the electromagnetic field generated by drive signals. When touching the touch display panel, the interference with the inductive electrode by the display panel may be alleviated, thereby ensuring the touch function of the touch display panel.

Embodiments of the disclosure further provide a touch display device, comprising any one of touch display panels recited above.

### BRIEF DESCRIPTION OF THE DRAWINGS

In order to more clearly illustrate the embodiments of the disclosure or the technical solutions in the prior art, the drawings to be used in the embodiments or the description of the prior art will be briefly described below. It is apparent that the drawings in the following description are only some embodiment of the disclosure, and other drawings may be obtained according to the structures shown in the drawings by a person skilled in the art without paying any creative work.

FIG. 1 is a schematic structural view of a touch display panel provided by an embodiment of the disclosure;

FIG. 2 is a schematic structural view of another touch display panel provided by an embodiment of the disclosure;

FIG. 3 is a schematic structural view of still another touch display panel provided by an embodiment of the disclosure;

FIG. 4 is a schematic structural view of adjacent drive sub-electrodes and inductive sub-electrodes in a touch display panel provided by an embodiment of the disclosure;

FIG. 5 is a schematic structural view of adjacent drive sub-electrodes and inductive sub-electrodes in another touch display panel provided by an embodiment of the disclosure;

FIG. 6 is a schematic structural view of another touch display panel provided by an embodiment of the disclosure;

FIG. 7 is a schematic structural view of still another touch display panel provided by an embodiment of the disclosure;

FIG. 8 is a side view of a touch display panel provided by an embodiment of the disclosure;

FIG. 9 is a top view of a touch display panel provided by an embodiment of the disclosure;

FIG. 10 is a top view of another touch display panel provided by an embodiment of the disclosure;

FIG. 11 is a side view of another touch display panel provided by an embodiment of the disclosure;

FIG. 12 is a top view of still another touch display panel provided by an embodiment of the disclosure;

FIG. 13 is a schematic flow chart of a manufacturing method for a touch display panel provided by an embodiment of the disclosure.

The achievement of the purposes, functional features and advantages of the disclosure will be further described with reference to the accompanying drawings.

### DETAILED DESCRIPTION OF PREFERRED EMBODIMENTS

With the development of the thinning of the touch display panel, the distance between the display panel and the touch electrode in the touch display panel is coming closer. However, when touching the touch display panel, since the distance between the display panel and the touch electrode is relatively closer, the display panel may interfere with the touch electrode. Specifically, a cathode in the touch panel and a drive signal may interface with the touch electrode, thereby affecting the touch sensitivity of the touch electrode.

In view of the above, embodiments of the disclosure provide a touch display panel, which may reduce the interference with the touch electrode by at least one of the cathode and the drive signal line in the display panel, thereby improving the touch sensitivity of the touch display panel.

The technical solutions of the disclosure are clearly and completely described below in conjunction with the specific embodiments of the disclosure and the corresponding drawings. It is apparent that the described embodiments are merely part of the embodiments of the disclosure rather than all the embodiments. Based on the embodiments in the disclosure, all the other embodiments obtained by a person skilled in the art without paying creative work will fall into the protection scope of the disclosure.

The touch display panel provided by the embodiments of the disclosure may be an on-cell or an out-cell or an in-cell touch display panel. The touch display panel may be applied to various modes of the display panel, and is not specifically limited herein.

In the touch display panel provided by the embodiments of the disclosure, a plurality of inductive electrodes and a plurality of drive electrodes may be located in the same or different electrically conductive layer, wherein the plurality of inductive electrodes and the plurality of drive electrodes may be transparent and electrically conductive materials, including but not limited to ITO (Chinese name: [symbol] , English name: Indium Tin Oxide); AgNW (silver nanowire), graphene, etc., or metal material such as metal mesh.

The encapsulation layer recorded in the embodiment of the disclosure may be a thin film encapsulation layer for encapsulating the display panel, or a substrate layer between a touch layer and the thin film encapsulation layer, or may include both the thin film encapsulation layer and the substrate layer and is not specifically limited herein. Wherein, if the encapsulation layer is the thin film encapsulation layer, the thin film encapsulation layer adopts a material with low dielectric constant; if the encapsulation layer is the substrate layer, the substrate layer adopts a material with low dielectric constant; if the encapsulation layer comprises the thin film encapsulation layer and the substrate layer, at least one of the thin film encapsulation layer and the substrate layer adopts a material with low dielectric constant.

The technical solutions provided by the embodiments of the disclosure will be described below in detail with reference to the accompanying drawings.

### Embodiment 1

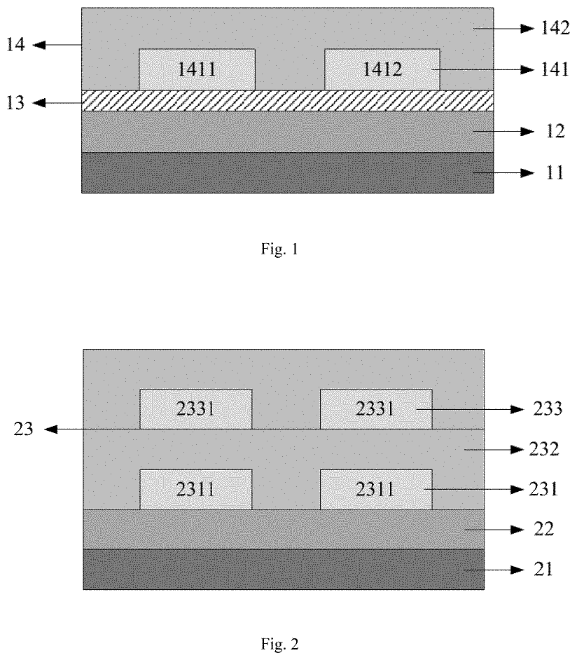

FIG. 1 is a schematic structural view of a touch display panel provided by an embodiment of the disclosure. The touch display panel is as follows.

In FIG. 1, the touch display panel may include a cathode 11, a thin film encapsulation layer 12, a substrate layer 13 (the thin film encapsulation layer 12 and the substrate layer 13 may be collectively referred to as an encapsulation layer), and a touch layer 14. The touch layer 14 includes an electrically conductive layer 141 and an insulative layer 142. The electrically conductive layer 141 includes an inductive electrode 1411 and a drive electrode 1412. The thin film encapsulation layer 12 covers the cathode 11 and may be used to encapsulate the cathode 11. The substrate layer 13 covers the thin film encapsulation layer 12, and the touch layer 14 covers the substrate layer 13.

A material for the thin film encapsulation layer 12 shown in FIG. 1 may be a material with low dielectric constant, and may specifically be a transparent material with low dielectric constant. As a preferred manner, the dielectric constant of the material with low dielectric constant may be between 3 and 8. Specifically, the material with low dielectric constant may be silicon oxide or silicon oxynitride, and may be other materials with low dielectric constant, which are not specifically limited in the embodiment of the disclosure.

In FIG. 1, the touch layer 14 may include a first electrically conductive layer 141 and a first insulative layer 142, wherein the first electrically conductive layer 141 may include an inductive electrode 1411 and a drive electrode 1412.

When the touch display panel shown in FIG. 1 is touched, inductive capacitance may be generated between the inductive electrode 1411 and the cathode 11. The thin film encapsulation layer 12 located between the cathode 11 and the inductive electrode 1411 may be regarded as a medium between capacitors composed of the inductive electrode 1411 and the cathode 11 (the inductive electrode 1411 and the cathode 11 may be regarded as one of the polar plates of the capacitor, respectively). Since the thin film encapsulation layer 12 adopts a material with low dielectric constant in the embodiment of the disclosure, compared with the prior art, the inductive capacitance between the inductive electrode 1411 and the cathode 11 may be reduced, thereby effectively alleviating the interference with the inductive electrode 1411 by the cathode 11.

Similarly, when the touch display panel shown in FIG. 1 is touched, inductive capacitance may also be generated between the drive electrode 1412 and the cathode 11. The thin film encapsulation layer 12 may be regarded as a medium between capacitors composed of the drive electrode 1412 and the cathode 11 (the drive electrode 1412 and the cathode 11 may be regarded as one of the polar plates of the capacitor, respectively). Since the thin film encapsulation layer 12 adopts a material with low dielectric constant in the embodiment of the disclosure, compared with the prior art, the inductive capacitance between the drive electrode 1412 and the cathode 11 may be reduced, thereby effectively alleviating the interference with the drive electrode 1412 by the cathode 11.

The touch display panel provided by the embodiment of the disclosure may alleviate the interference with the inductive electrode by the cathode and the interference with the drive electrode by the cathode, compared with the prior art, the touch sensitivity of the touch display panel may be effectively improved.

In the embodiment of the disclosure, in order to further reduce the inductive capacitance between the cathode 11 and the inductive electrode 1411, and the inductive capacitance between the cathode 11 and the drive electrode 1412, in case that thickness requirement of the touch display panel has been satisfied, the thickness of the thin film encapsulation layer 12 may also be appropriately increased.

In the embodiment of the disclosure, as a preferred manner, the thickness of the thin film encapsulation layer 12 may be between 1 and 10 μm.

In FIG. 1, an electrically conductive layer 141 may be formed over the substrate layer 13, and the electrically conductive layer 141 is covered with the insulative layer 142. In other implementations, the substrate layer 13 may be integrated with the touch layer 14.

In the embodiment of the disclosure, in order to reduce the inductive capacitance between the cathode 11 and the inductive electrode 1411 and the drive electrode 1412 in the touch layer 14 to the greatest extent, the substrate layer 13 may also adopt a material with low dielectric constant, and may specifically be a transparent material with low dielectric constant. Wherein the dielectric constant of the material with low dielectric constant may be between 3 and 8, and may specifically be silicon oxide or silicon oxynitride, and may be other materials with low dielectric constant, which are not specifically limited in the embodiment of the disclosure.

Thus, since both the thin film encapsulation layer 12 and the substrate layer 13 between the cathode 11 and the touch layer 14 adopt the material with low dielectric constant, the inductive capacitance between the cathode 11 and the inductive electrode 1411 and the inductive capacitance between the cathode 11 and the drive electrode 1412 may be further reduced, thereby further alleviating the interference with the inductive electrode 1411 and the drive electrode 1412 by the cathode 11, and improving the touch sensitivity of the touch display panel.

It should be noted that, in practical applications, at least one of the thin film encapsulation layer 12 and the substrate 13 shown in FIG. 1 may adopt at least one material with low dielectric constant, as long as the inductive capacitance between the cathode 11 and the inductive electrode 1411 and the inductive capacitance between the cathode 11 and the drive electrode 1412 may be reduced. When both the thin film encapsulation layer 12 and the base substrate 13 adopt a material with low dielectric constant, the materials with low dielectric constant adopted by them may be the same or different, and are not specifically limited herein.

It should be noted that, in other implementations, in the touch display panel shown in FIG. 1, the base substrate 13 may also be removed, that is, the touch layer 14 may be directly formed on the thin film encapsulation layer 12, in case that the thickness requirement of the touch display panel has been satisfied, the thickness of the thin film encapsulation layer 12 may be designed to be thicker, so that the inductive capacitance between the cathode 11 and the inductive electrode 1411 and the inductive capacitance between the cathode 11 and the drive electrode 1412 may be reduced to the greatest extent.

In FIG. 1, when the touch display panel is touched, inductive capacitance may also be generated between the inductive electrode 1411 and the drive electrode 1412 in the touch layer 14, the insulative layer 142 may be regarded as a medium between capacitors composed of the inductive electrode 1411 and the drive electrode 1412 (the inductive electrode 1411 and the drive electrode 1412 may be regarded as one of the polar plates of the capacitor, respectively).

In order to further improve the touch sensitivity of the touch display panel, the insulative layer 142 may also adopt a material with high dielectric constant. In this way, the inductive capacitance generated between the inductive electrode 1411 and the drive electrode 1412 may be increased, thereby achieving the purpose of improving touch sensitivity.

As a preferred manner, the material with high dielectric constant adopted in the insulative layer 142 may be a transparent material with high dielectric constant, the material with high dielectric constant may have a dielectric constant greater than 30, and the material may specifically be silicon nitride, or titanium oxide, or may be other materials with high dielectric constant such as alumina, magnesia, or zirconia, and are not specifically limited herein.

In order to further increase the inductive capacitance between the inductive electrode 1411 and the drive electrode 1412, in the embodiment of the disclosure, the thickness of the insulative layer 142 may also appropriately reduced. As a preferred manner, the thickness of the insulative layer 142 may be set between 0.01 and 10 μm.

The touch display panel provided by the embodiment of the disclosure includes: a cathode 11, an encapsulation layer, and a touch layer 14, wherein the encapsulation layer is located between the cathode 11 and the touch layer 14, and the encapsulation layer includes a thin film encapsulation layer 12 and a substrate layer 13, the touch layer 14 includes an inductive electrode 1411 and a drive electrode 1412, and the inductive electrode 1411 and the drive electrode 1412 are located in the same electrically conductive layer 141, and the encapsulation layer adopts a material with low dielectric constant. In this way, the encapsulation layer between the cathode and the touch layer in the touch display panel adopting the material with low dielectric constant may reduce the inductive capacitance between the cathode and the inductive electrode and the drive electrode in the touch layer. When touching the touch display panel, owing to the reduced inductive capacitance between the cathode and the inductive electrode and the drive electrode, compared with the prior art, the interference with the touch electrode by the cathode may be alleviated, thereby reducing the damage to the touch function of the touch display panel and improving the touch sensitivity of the touch display panel.

### Embodiment 2

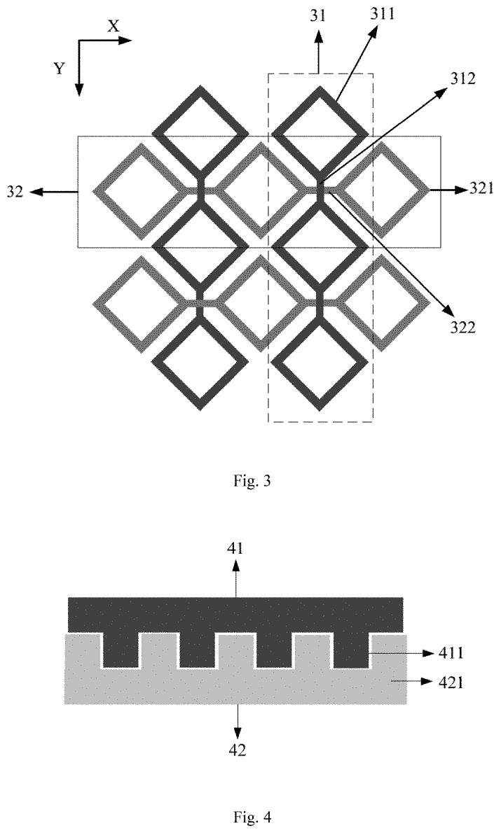

FIG. 2 is a schematic structural view of another touch display panel provided by an embodiment of the disclosure. The touch display panel is as follows.

In FIG. 2, the touch display panel may include a cathode 21, a thin film encapsulation layer 22, and a touch layer 23. The thin film encapsulation layer 22 is located between the cathode 21 and the touch layer 23, and the touch layer 23 includes a first electrically conductive layer 231, an insulative layer 232, and a second electrically conductive layer 233. The insulative layer 232 is located between the first electrically conductive layer 231 and the second electrically conductive layer 233. The first electrically conductive layer 231 includes a drive electrode 2311, and the second electrically conductive layer 233 includes an inductive electrode 2331. The thin film encapsulation layer 12 may be used to encapsulate the cathode 21.

Compared with the touch display panel shown in FIG. 1, the touch display panel shown in FIG. 2 is different in that the drive electrode 2311 and the inductive electrode 2331 in FIG. 2 are located in different electrically conductive layers, and the touch layer 23 may be directly formed on the film encapsulation layer 22.

The material for the thin film encapsulation layer 22 shown in FIG. 2 may be a material with low dielectric constant, and may specifically be a transparent material with low dielectric constant. A thickness of the material with low dielectric constant and the magnitude of the dielectric constant may refer to the contents described in Embodiment 1, and the description thereof will not be repeated here.

The thin film encapsulation layer 22 adopting a material with low dielectric constant may reduce the inductive capacitance between the drive electrode 2311 and the cathode 21 and the inductive capacitance between the inductive electrode 2331 and the cathode 21. When the touch layer 23 is touched, the interference with the drive electrode 2311 and the inductive electrode 2331 by the cathode 21 may be effectively alleviated, thereby improving the touch sensitivity of the touch display panel.

In the embodiment of the disclosure, in order to further improve the touch sensitivity of the touch display panel, the insulative layer 232 shown in FIG. 2 may also adopt a material with high dielectric constant, and may specifically be a transparent material with high dielectric constant. Wherein the thickness of the material with high dielectric constant and the magnitude of the dielectric constant may refer to the contents described in Embodiment 1, and the description thereof will not be repeated here.

In FIG. 2, when the touch display panel is touched, the inductive capacitance may be generated between the drive electrode 2311 and the inductive electrode 2331 in the touch layer 23. The insulative layer 232 may be regarded as a medium between capacitors composed of the drive electrode 2311 and the inductive electrode 2331 (the drive electrode 2311 and the inductive electrode 2331 may be regarded as one of the polar plates of the capacitor, respectively).

Since the insulative layer 232 of FIG. 2 adopts a material with high dielectric constant, compared with the prior art, the inductive capacitance generated between the drive electrode 2311 and the inductive electrode 2331 may be increased. In this way, when the touch layer 23 is touched, the interference with the drive electrode 2311 and the inductive electrode 2331 by the cathode 21 may be alleviated by increasing the inductive capacitance between the drive electrode 2311 and the inductive electrode 2331, thereby improving the touch sensitivity of the touch display panel.

The touch display panel provided by the embodiment of the disclosure includes a cathode 21, a thin film encapsulation layer 22, and a touch layer 23. The touch layer includes an inductive electrode 2331 and a drive electrode 2311, and the inductive electrode 2331 and the drive electrode 2311 are located in different electrically conductive layers. The thin film encapsulation layer 22 is located between the cathode 21 and the touch layer 23, and the thin film encapsulation layer 22 adopts a material with low dielectric constant.

The thin film encapsulation layer between the cathode and the touch layer in the touch display panel adopting the material with low dielectric constant may reduce the inductive capacitance between the cathode and the inductive electrode and the drive electrode in the touch layer. When touching the touch display panel, owing to the reduced inductive capacitance between the cathode and the inductive electrode and between the cathode and the drive electrode. Compared with the prior art, the interference with the touch electrode by the cathode may be alleviated, thereby reducing the damage to the touch function of the touch display panel and improving the touch sensitivity of the touch display panel.

### Embodiment 3

In the embodiment of the disclosure, as for the touch display panel shown in FIG. 1 and FIG. 2, in order to further alleviate the influence of a cathode on a touch electrode in a touch display panel, the interior of at least one the touch electrode may be hollowed out. In this way, the interference with the touch electrode by the cathode may be alleviated by reducing the relative area between the cathode and the touch electrode, thereby improving the touch sensitivity of the touch display panel.

It should be noted that, in the touch display panel provided by the embodiment of the disclosure, the touch electrode may include an inductive electrode and a drive electrode. The interior of the at least one touch electrode being hollowed out may include: the interior of at least one inductive electrode being hollowed out or the interior of at least one drive electrode being hollowed out, or both the interior of at least one inductive electrode being hollowed out and the interior of at least one drive electrode being hollowed out, which is not specifically limited herein.

However, in practical applications, generally, the interference with the inductive electrode by the cathode is greater than the interference with the drive electrode by the cathode. Therefore, as a preferred manner, the interior of at least one inductive electrode may be hollowed out.

Please refer to FIG. 3 for details.

FIG. 3 is a schematic structural view of a touch display panel provided by an embodiment of the disclosure.

As shown in FIG. 3, the touch display panel includes a plurality of (two is only shown in FIG. 3) inductive electrodes 31 arranged along a first direction (X direction as shown in FIG. 3) and a plurality of (two is only shown in FIG. 3) drive electrodes 32 arranged along a second direction (Y direction as shown in FIG. 3), and the plurality of inductive electrodes 31 and the plurality of drive electrodes 32 may be intersected with each other, and the first direction may be perpendicular to the second direction.

Each of the inductive electrodes 31 may include a plurality of inductive sub-electrodes 311, and each of the drive electrodes 32 may include a plurality of drive sub-electrodes 321. Each of the inductive sub-electrodes 311 and each of the drive sub-electrodes 321 may have a diamond shape. In other implementations, each of the inductive sub-electrodes 311 and each of the drive sub-electrodes 321 may also have a strip shape, and is not specifically limited herein.

In FIG. 3, as for one of the inductive electrodes 31, the interior of the three inductive sub-electrodes 311 included therein may be hollowed out so that the relative area between the inductive electrode 31 and the cathode may be reduced to the greatest extent In other implementations, the interior of some inductive sub-electrodes included in one inductive electrode may be hollowed out and the interior of the other inductive sub-electrodes included in one inductive electrode may not be hollowed out. The number of the inductive sub-electrodes with the interior being hollowed out may be determined according to actual conditions and is not specifically limited herein. The inductive sub-electrodes with the interior hollowed out may be adjacent inductive sub-electrodes or non-adjacent inductive sub-electrodes, and are not specifically limited herein.

In the embodiment of the disclosure, as for one of the inductive electrodes 31, the plurality of inductive sub-electrodes 311 included therein may be sequentially connected by a first electrically conductive bridge 312, and as for one of the drive electrodes 31, the plurality of drive sub-electrodes 321 included therein may be sequentially connected by a second electrically conductive bridge 322. The first electrically conductive bridge 312 and the second electrically conductive bridge 322 are insulated from each other.

The plurality of inductive electrodes 31 and the plurality of drive electrodes 32 shown in FIG. 3 may be located in the same electrically conductive layer, and the first electrically conductive bridge 312 and the second electrically conductive bridge 322 may be located in different electrically conductive layers. For example, if the plurality of inductive electrodes 31 and the plurality of drive electrodes 32 are located in the electrically conductive layer A, the first electrically conductive bridge 312 may be located in the electrically conductive layer A, and the second electrically conductive bridge 322 may be located in the electrically conductive layer B (or, the first electrically conductive bridge 312 may be located in the electrically conductive layer B and the second electrically conductive bridge 322 may be located in the electrically conductive layer A). The positions of the electrically conductive layer A, the electrically conductive layer B and the cathode in the touch display panel from top to bottom may sequentially be: the electrically conductive layer A, the electrically conductive layer B, and the cathode; or the electrically conductive layer B, the electrically conductive layer A, and the cathode.

The plurality of inductive electrodes 31 and the plurality of drive electrodes 32 shown in FIG. 3 may also be located in different electrically conductive layers, and the first electrically conductive bridge 312 and the second electrically conductive bridge 322 are also located in different electrically conductive layers. For example, when the plurality of inductive electrodes 31 are located in the electrically conductive layer A, the first electrically conductive bridge 312 is also located in the electrically conductive layer A. When the plurality of drive electrodes 31 are located in the electrically conductive layer B, the second electrically conductive bridge 322 is also located in the electrically conductive layer B. The positions of the electrically conductive layer A, the electrically conductive layer B, and the cathode in the touch display panel from top to bottom may sequentially be: the electrically conductive layer A, the electrically conductive layer B, and the cathode.

In the embodiment of the disclosure, on the basis that the interior of the inductive electrode is hollowed out to alleviate the interference with the inductive electrode by the cathode, in order to alleviate the interference with the drive electrode by the cathode, the interior of at least one drive electrode in the touch display panel may be hollowed out. Wherein, the size of the hollow-out area of the interior of the drive electrode may be determined according to actual needs, and is not specifically limited herein.

As shown in FIG. 3, the interior of all of the three drive sub-electrodes 321 included in each of the drive electrodes 32 in FIG. 3 may be hollowed out. In this way, the relative area between the drive electrode 32 and the cathode may be reduced to the greatest extent, thereby alleviating the interference with the drive electrode 32 by the cathode. In other implementations, the interior of some drive sub-electrodes included in one drive electrode may be hollowed out, and the interior of the other drive sub-electrodes included in one drive electrode may not be hollowed out. The number of the drive sub-electrodes with the interior being hollowed out may be determined according to actual conditions and is not specifically limited herein. The drive sub-electrodes with the interior being hollowed out may be adjacent drive sub-electrodes or non-adjacent drive sub-electrodes, and are not specifically limited herein.

It should be noted that, in practical applications, as for the entire touch display panel, the interior of all of the inductive sub-electrodes included therein may be hollowed out, and the interior of the drive sub-electrode is not hollowed out; or the interior of the inductive sub-electrode and the interior of the drive sub-electrode may be hollowed out; or the interior of part of the inductive sub-electrodes may be hollowed out and the interior of part of the drive sub-electrodes may be hollowed out, which is not specifically limited in the embodiment of the disclosure.

In another embodiment provided by the disclosure, on the basis that the interior of at least one inductive sub-electrode included in the touch display panel is hollowed out, or on the basis that the interior of at least one inductive sub-electrode included in the touch display panel is hollowed out and the interior of at least one drive sub-electrode included in the touch display panel is hollowed out, the adjacent inductive sub-electrodes and the drive sub-electrodes may be designed as a mutual nested structure in order to further improve the touch sensitivity of the touch display panel.

Specifically, the adjacent drive sub-electrodes and the inductive sub-electrodes are nested with each other, and may include:

A side of the drive sub-electrode and a side of the adjacent inductive sub-electrode each have a concave-convex structure, and the shape of two concave-convex structures is consistent and matched with each other.

The convex portion of the drive sub-electrode may be nested in the concave portion of the inductive sub-electrode, and the convex portion of the inductive sub-electrode may be nested in the concave portion of the drive sub-electrode. The concave portion and the convex portion of the concave-convex structure may be rectangular, square, curved or other shapes, and are not specifically limited herein.

As shown in FIG. 4, mark 41 in FIG. 4 refers to a side of the inductive sub-electrode 311 shown in FIG. 3, and mark 42 refers to a side of the drive sub-electrode 321 shown in FIG. 3. The side 41 has a plurality of rectangular concave-convex structures 411, and the side 42 has a plurality of rectangular concave-convex structures 421, and two concave-convex structures are matched with each other. In this way, the relative area between the inductive sub-electrode 311 shown in FIG. 3 and the drive sub-electrode 321 shown in FIG. 3 may be increased, and the distance between the inductive sub-electrode 311 and the drive sub-electrode 321 may be shortened, thereby the induced capacitance between the inductive sub-electrode 311 and the drive sub-electrode 321 can be increased.

For the entire touch display panel shown in FIG. 3, at least one of a side of the inductive sub-electrodes 311 and a side of the adjacent drive sub-electrode 321 may be configured as the above-described concave-convex structure, and preferably, a side of each inductive sub-electrode 311 and a side of the drive sub-electrode 321 connected thereto may be configured as the concave-convex structure, so that the mutual capacitance between the plurality of drive electrodes and the plurality of inductive electrodes in the touch display panel may be increased to the greatest extent, thereby the touch sensitivity of the touch display panel can be improved.

In this way, by designing the inductive sub-electrode and the adjacent drive sub-electrode as a concave-convex structure, on the one hand, the relative area between the inductive sub-electrode and the drive sub-electrode may be increased, and on the other hand, the distance between the inductive sub-electrode and the drive sub-electrode may be shortened. The mutual capacitance between the inductive electrode and the drive electrode may be effectively increased. When the touch display device is touched, change in capacitance detected by the inductive electrode may be increased, and the detection sensitivity of the inductive electrode and the touch sensitivity of the touch display panel may be effectively improved.

In an embodiment of the disclosure, the adjacent drive sub-electrodes and the inductive sub-electrodes are nested with each other, and may further include:

Both the side of the drive sub-electrodes and the side of the adjacent inductive sub-electrodes are spiral structures, and both spiral structures have the same shape and are matched with each other.

A spiral wall of the drive sub-electrode may be nested into a gap of a spiral wall of the inductive sub-electrode, and the spiral wall of the inductive sub-electrode may be nested into a gap of the spiral wall of the drive sub-electrode, and two different spiral walls may constitute a Fermat spiral structure.

As shown in FIG. 5, mark 51 in FIG. 5 may refer to a side of the inductive sub-electrode 311 shown in FIG. 3, and mark 52 may refer to a side of the drive sub-electrode 321 shown in FIG. 3, and the side 51 is a spiral structure and has a spiral wall 511, and the side 52 is a spiral structure and has a spiral wall 521. The spiral wall 511 and the spiral wall 521 have the same shape, and the spiral wall 511 is nested into a gap of the spiral wall 521, and the spiral wall 521 is nested into a gap of the spiral wall 511. In this way, the relative area between the inductive sub-electrode 311 shown in FIG. 3 and the drive sub-electrode 321 shown in FIG. 3 may be increased, and the distance between the inductive sub-electrode 311 and the drive sub-electrode 321 may be shortened, and thereby the induced capacitance between the inductive sub-electrode 311 and the drive sub-electrode 321 can be increased.

For the touch display panel shown in FIG. 3, the side of the at least one inductive sub-electrode 311 and the side of the adjacent drive sub-electrode 321 may be configured as the spiral structure described above, and preferably, the side of the at least one inductive sub-electrode 311 and the side of the adjacent drive sub-electrode 321 may be configured as the spiral structure described above, so that the mutual capacitance between the plurality of drive electrodes and the plurality of inductive electrodes in the touch display panel may be increased to the greatest extent, thereby improving the touch sensitivity of the touch display panel.

In this way, by designing the inductive sub-electrode and the adjacent drive sub-electrode as a spiral structure, on the one hand, the relative area between the inductive sub-electrode and the drive sub-electrode may be increased, and on the other hand, the distance between the inductive sub-electrode and the drive sub-electrode may be shortened. The mutual capacitance between the inductive electrode and the drive electrode may be effectively increased. When the touch display device is touched, change in capacitance detected by the inductive electrode may be increased, and the detection sensitivity of the inductive electrode and the touch sensitivity of the touch display panel may be effectively improved.

It should be noted that, in practical applications, for the entire touch display panel, sides of all the drive sub-electrodes and sides of the adjacent inductive sub-electrodes may be configured as a concave-convex structure, or a spiral structure, or sides of part of the drive sub-electrodes and sides of the adjacent inductive sub-electrodes be configured as a concave-convex structure, and sides of the other drive sub-electrodes and sides of the adjacent inductive sub-electrodes may be configured as a spiral structure, and the embodiment of the disclosure is not specifically limited thereto.

The touch display panel provided by the embodiment of the disclosure includes a cathode and a plurality of inductive electrodes 31, and the interior of at least one of the inductive electrodes 31 is hollowed out to reduce a relative area between the inductive electrode 31 and the cathode. In the embodiment of the disclosure, by hollowing out the interior of the inductive electrodes of the touch display panel, the relative area between the inductive electrode and the cathode of the touch display panel may be reduced, thereby reducing the inductive capacitance between the inductive electrode and the cathode. In this way, when the touch display panel is touched, since the inductive capacitance between the cathode and the inductive electrode becomes smaller, a significant change in capacitance may be detected by the inductive electrode, thereby effectively reducing the interference with the inductive electrode by the cathode, and improving the detection sensitivity of the inductive electrode and the touch sensitivity of the touch display panel.

### Embodiment 4

In the embodiment of the disclosure, as for the touch display panel shown in FIG. 1 and FIG. 2, the area in the cathode corresponding to the position of the touch electrode may also be hollowed out, so that the interference with the touch electrode by the cathode may also be alleviated, thereby improving the touch sensitivity of the touch display panel.

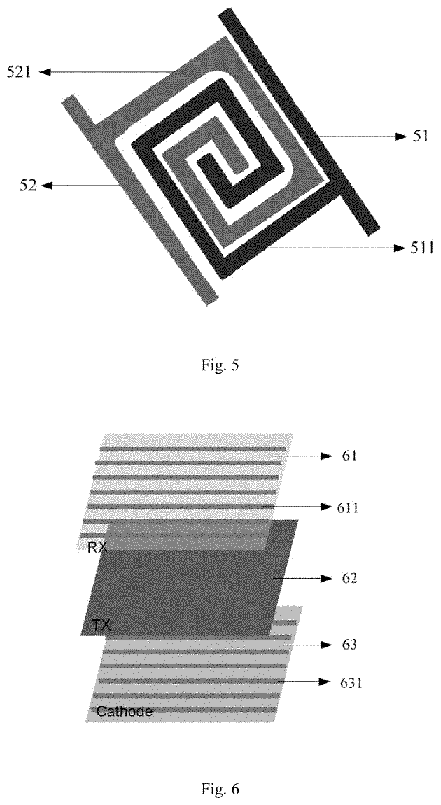

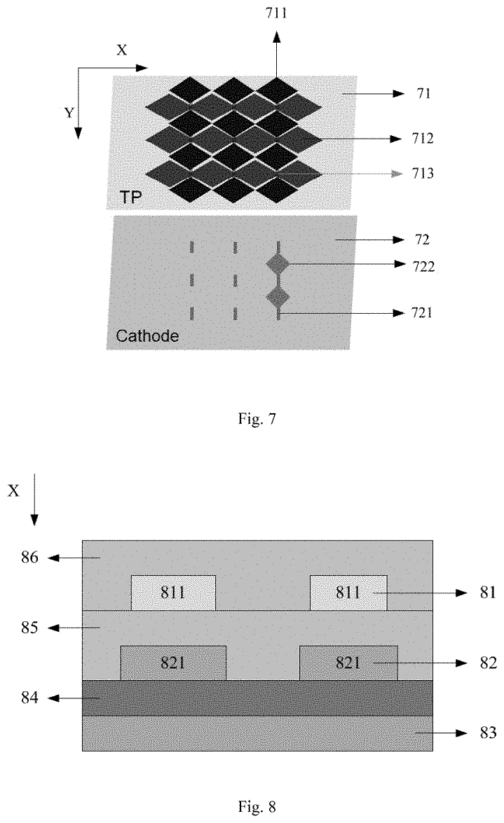

Please refer to FIG. 6 and FIG. 7 for details.

FIG. 6 is a schematic structural view of a touch display panel provided by an embodiment of the disclosure. The touch display panel is as follows.

The touch display panel shown in FIG. 6 may include an inductive electrode layer 61, a drive electrode layer 62, and a cathode layer 63. The positions from top to bottom may be: the inductive electrode layer 61, the drive electrode layer 62 and the cathode layer 63. The inductive electrode layer 61 includes a plurality of inductive electrodes 611, the drive electrode layer includes a plurality of drive electrodes 62 (not specifically shown in FIG. 6), and the cathode layer 63 may be regarded as a cathode of the touch display panel.

In FIG. 6, the cathode may include a plurality of hollow-out areas 631, and the number of the hollow-out areas 631 is equal to the number of inductive electrodes 611 (7 inductive electrodes 611 and 7 hollow-out areas 631 are shown in FIG. 6). There is one-to-one correspondence between the position of each hollow-out area 631 and the position of each inductive electrode 611.

In this way, as for the entire cathode, the relative area between the cathode and the inductive electrode may be reduced, thereby reducing the inductive capacitance between the cathode and the inductive electrode. When the touch display panel is touched, the interference with the inductive electrode by the cathode may be effectively alleviated, thereby improving the touch sensitivity of the touch display panel.

It should be noted that, in the touch display panel shown in FIG. 6, the number of the hollow-out areas included in the cathode may be smaller than that of the inductive electrodes. For example, the cathode of the touch display panel shown in FIG. 6 may include five hollow-out areas, and the position of each hollow-out area may correspond to that of one inductive electrode (i.e., cathode areas corresponding to two inductive electrode positions are not hollowed out). Thus, as for the entire cathode, the relative area between the cathode and the inductive electrode may also be reduced, thereby alleviating the interference with the inductive electrode by the cathode.

In addition, the number of the hollow-out areas included in the cathode may be greater than that of the inductive sub-electrodes included in the inductive electrode. For example, as for one of the inductive electrodes shown in FIG. 6, the cathode area corresponding to the position thereof may be hollowed out to obtain two or more hollow-out areas, and the positions of the hollow-out areas correspond to those of the inductive electrodes. Thus the relative area between the cathode and the inductive electrode can be reduced, thereby alleviating the interference with the inductive electrode by the cathode.

In practical applications, the number of the hollow-out areas included in the cathode may be determined according to the sensitivity requirement of the inductive electrode, and is not specifically limited herein. As a preferred manner, it may be determined that the number of the hollow-out areas included in the cathode is the same as that of the inductive electrodes, and there is one-to-one correspondence between the positions of the hollow-out areas and those of the inductive electrodes.

In FIG. 6, the shape of each hollow-out area 631 may be equal to that of the inductive electrode 611, that is, each hollow-out area 631 may have a strip shape, and the area of each hollow-out area 631 may be equal to that of the inductive electrode 611 corresponding to the position thereof. Thus, as for the entire cathode, the relative area between the cathode and the inductive electrode may be reduced to the greatest extent, thereby effectively alleviating the interference with the inductive electrode by the cathode.

In addition, the area of each hollow-out area 631 in FIG. 6 may also be smaller than the area of the inductive electrode 611 corresponding to the position thereof, such that as for the entire cathode, in the premise that the relative area between the cathode and the inductive electrodes may be reduced, the display function of the cathode is not damaged as much as possible. The specific area of each hollow-out area 631 may be determined according to the detection sensitivity requirement of the inductive electrode or the touch sensitivity requirement of the touch display panel, and is not specifically limited herein.

The touch display panel provided by the embodiment of the disclosure includes a cathode and a plurality of inductive electrodes 611. The cathode includes at least one hollow-out area 631, and the position of the hollow-out area 631 corresponds to that of the inductive electrode 611 to reduce the relative area between the cathode and the inductive electrode 611. In this way, as for the entire cathode, the relative area between the cathode and the inductive electrode may be reduced by hollowed out the area of the cathode in the touch display panel corresponding to the inductive electrode, thereby reducing the inductive capacitance between the cathode and the inductive electrode. In this way, when touching the touch display panel, owing to the reduced inductive capacitance between the cathode and the inductive electrode, compared with the prior art, the interference with the inductive electrode by the cathode may be alleviated and change in capacitance detected by the inductive electrode may be increased, thereby improving the detection sensitivity of the inductive electrode and further improving the touch sensitivity of the touch display panel.

FIG. 7 is a schematic structural view of another touch display panel provided by an embodiment of the disclosure. The touch display panel is as follows.

The touch display panel as shown in FIG. 7 includes a touch electrode layer 71 and a cathode layer 72. The touch electrode layer 71 may be located above the cathode layer 72. The touch electrode layer 71 may include a plurality of inductive electrodes 711 and a plurality of drive electrodes 712. The cathode layer 72 may be regarded as a cathode of the touch display panel.

In FIG. 7, the plurality of inductive electrodes 711 and the plurality of drive electrodes 712 are located in the same electrically conductive layer 71 (i.e., the touch electrode layer 71) and intersected with each other. The plurality of inductive electrodes 711 may be arranged in a first direction (X-direction in FIG. 7), and the plurality of drive electrodes 712 may be arranged in a second direction (Y-direction in FIG. 7). The first direction intersects with the second direction. In the embodiment of the disclosure, the plurality of inductive electrodes 711 and the plurality of drive electrodes 712 may be transparent and electrically conductive materials or metal materials.

As for one of the inductive electrodes 711, the inductive electrode 711 may include a plurality of sequentially connected inductive sub-electrodes (four inductive sub-electrodes shown in FIG. 7), and each of them has a diamond shape; For one drive electrode 712, the drive electrode 712 may include four sequentially connected drive sub-electrodes, and each of them has a diamond shape.

It should be noted that, in other implementations, as to one of the inductive electrodes, each inductive sub-electrode included therein may also have a strip shape, or some inductive sub-electrodes may have a diamond shape and the other inductive sub-electrodes may have a strip shape, and is not specifically limited herein. Similarly, as to one of the drive electrodes, each drive sub-electrodes included therein may also have a strip shape, or some drive sub-electrodes may have a diamond shape, and the other drive sub-electrodes may have a strip shape, as long as the pattern of the inductive sub-electrode and the drive sub-electrode may cover the display area of the touch display panel.

In the touch display panel shown in FIG. 7, as for each of the inductive electrodes 711, the inductive electrode 711 may include at least one electrode area 713 intersected with the drive electrode 712. As shown in FIG. 7, one inductive electrode 711 includes three electrode areas 713, and the three inductive electrodes 711 include nine electrode areas 713. The inductive electrode corresponding to the position of each electrode area 713 is not connected to the drive electrode.

It should be noted that the plurality of electrode areas 713 in which the inductive electrode 711 is intersected with the drive electrode 712 shown in FIG. 7 are generally bridges for connecting the plurality of inductive sub-electrodes. In the embodiment of the disclosure, the plurality of electrode areas 713 may be regarded as part of the inductive electrodes 711. The inductive capacitance may be generated between the electrode area 713 and the cathode. When the display touch surface is touched, the cathode would interfere with the inductive electrode 711 by the electrode area 713.

In the touch display panel shown in FIG. 7, at least one hollow-out area 721 may be included in the cathode layer 72, and the position of each hollow-out area 721 corresponds to the position of one electrode area 713, respectively. As shown in FIG. 7, the cathode layer 72 includes nine hollow-out areas 721. There is a one-to-one correspondence between the position of each hollow-out area 721 and the position of one of the nine electrode areas 713 included in the electrode layer 71. In this way, the relative area between the cathode and the electrode area may be reduced, thereby reducing the relative area between the cathode and the inductive electrode, and alleviating the interference with the inductive electrode by the cathode.

The number of the hollow-out areas 721 included in the cathode described in FIG. 7 is equal to that of the electrode areas 713. In other implementations, the number of the hollow-out areas 721 may be smaller than that of the inductive areas 713. In this way, the relative area between the cathode and the inductive electrode may also be reduced, thereby alleviating the interference with the inductive electrode by the cathode.

In FIG. 7, as for one of the hollow-out areas 721, the shape of the hollow-out area 721 may be the same as that of the inductive area 713 corresponding to the position of the hollow-out area 721. As shown in FIG. 7, the inductive area 713 may have a strip shape, and the hollow-out area 721 may also have a strip shape. In addition, the area of the hollow-out area 721 may also be the same as that of the inductive area 713 corresponding to the position of the hollow-out area 721, so that the relative area between the hollow-out area 721 and the inductive area 713 may be reduced to the greatest extent, thereby effectively reducing the relative area between the cathode and the inductive electrode.

In addition, the area of the hollow-out area 721 may also be smaller than that of the inductive area 713 corresponding to the position of the hollow-out area 721, to reduce the area of the hollow-out area of the cathode, thereby avoiding damage to the display function of the cathode.

The cathode layer 72 shown in FIG. 7 may include a plurality of hollow-out areas 722 in addition to the plurality of hollow-out areas 721, and the position of each of the hollow-out areas 722 may correspond to that of one of the inductive sub-electrodes. Specifically, the number of the hollow-out areas 722 may not be greater than that of the inductive sub-electrodes, which may be specifically determined according to actual needs, and is not specifically limited herein. For one of the hollow-out areas 722, the shape of the hollow-out area 722 may be the same as the shape of the inductive sub-electrode 711 corresponding to the position of the hollow-out area 722, and the area of the hollow-out area 722 may be smaller than that of the inductive sub-electrode 711. In this way, based on the cathode area corresponding to the electrode area being hollowed out, the cathode area corresponding to the at least one inductive sub-electrode is hollowed out, thereby effectively reducing the relative area between the inductive electrode and the cathode, thereby alleviating the interference with the inductive electrode by the cathode.

It should be noted that, in practical applications, it may be preferable that the cathode portion corresponding to the electrode area in which the inductive electrode is overlapped with the drive electrode is hollowed out, because the interference with the inductive electrode by the cathode area corresponding to the position of the electrode area is more obvious than the interference with the inductive electrode by the cathode area corresponding to the position of the inductive sub-electrode. Therefore, in order to effectively alleviate the interference with the inductive electrode by the cathode, and avoid damage to the display function of the cathode as far as possible, preferably, the position in the cathode corresponding to the electrode area may be hollowed out.

The touch display panel provided by the embodiment of the disclosure includes a cathode, a plurality of inductive electrodes 711, and a plurality of drive electrodes 712. The plurality of inductive electrodes 711 and the plurality of drive electrodes 712 are located in the same electrically conductive layer 71, and are intersected with each other and include at least one intersecting electrode area 713. The cathode includes at least one hollow-out area 721, and the position of each hollow-out area 721 corresponds to the position of one of the electrode areas 713.

In this way, the relative area between the cathode and the inductive electrode may be reduced by hollowing out the area in the cathode corresponding to the overlapping portion between the inductive electrode and the drive electrode, thereby reducing the inductive capacitance between the cathode and the inductive electrode. In this way, when touching the touch display panel, owing to the reduced inductive capacitance between the cathode and the inductive electrode, compared with the prior art, the interference with the inductive electrode by the cathode may be alleviated and change in capacitance detected by the inductive electrode may be increased, thereby improving the detection sensitivity of the inductive electrode and further improving the touch sensitivity of the touch display panel.

### Embodiment 5

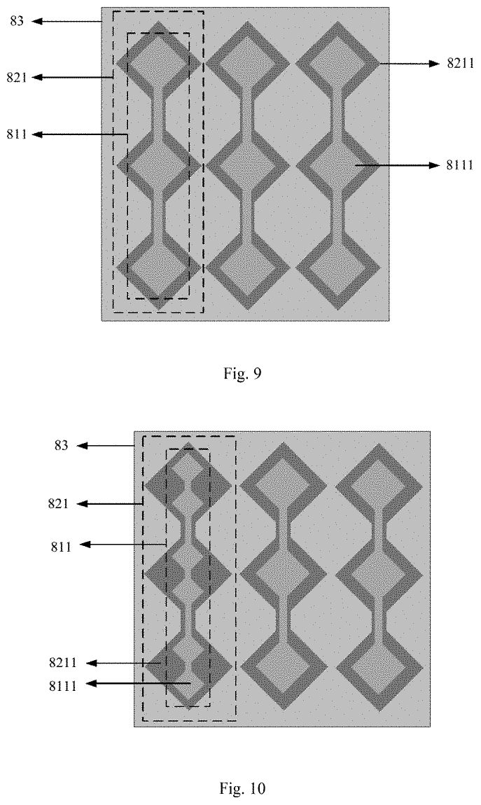

FIG. 8 is a side view of a touch display panel provided by an embodiment. FIG. 9 is a top view of the touch display panel shown in FIG. 8. The touch display panel provided by this embodiment may reduce the interference with the touch electrode by drive signals on the display panel. The touch display panel is as follows.

In FIG. 8, the touch display panel may include a first electrically conductive layer 81, a second electrically conductive layer 82, and a display panel 83. The first electrically conductive layer 81 includes a plurality of inductive electrodes 811, and the second electrically conductive layer 82 includes a plurality of drive electrode 821. The second electrically conductive layer 82 is located between the first electrically conductive layer 81 and the display panel 83. In addition, the touch display panel shown in FIG. 8 may further include an encapsulation layer 84, an insulative layer 85, and a protective layer 86. The encapsulation layer 84 is located between the second electrically conductive layer 82 and the display panel 83, and the encapsulation layer 84 may be a thin film encapsulation layer for encapsulating the display panel, and a substrate layer among thin film encapsulation layer, the touch layer and the thin film encapsulation layer, and may also include both the thin film encapsulation layer and the substrate layer, which is not specifically limited here.

The insulative layer 85 is located between the first electrically conductive layer 81 and the second electrically conductive layer 82 for insulating the inductive electrode 811 from the drive electrode 821. The protective layer 86 covers the first electrically conductive layer 81 and is used for protecting the inductive electrode 811.

In the embodiment of the disclosure, an orthographic projection area of the plurality of inductive electrodes 811 on the display panel 83 falls into an orthographic projection area of the plurality of drive electrodes 821 on the display panel 83. Specifically:

The X direction in FIG. 8 may be regarded as an orthogonal projection direction of the inductive electrode 811 on the display panel 83, and an orthogonal projection direction of the drive electrode 821 on the display panel 83. As can be seen from FIG. 8, a width of the orthographic projection area of the inductive electrode 811 on the display panel 83 falls into a width of the orthographic projection area of the drive electrode 821 on the display panel 83.

FIG. 9 is a top view of the touch display panel shown in FIG. 8, a direction perpendicular to the display panel 83 may be regarded as an orthographic projection direction of the inductive electrode 811 on the display panel 83, and an orthographic projection direction of the drive electrode 821 on the display panel 83. As can be seen in conjunction with FIGS. 8 and 9, the orthographic projection area of the inductive electrode 811 on the display panel 83 falls into the orthographic projection area of the drive electrode 821 on the display panel 83.

Thus, since the drive electrode 821 is located between the inductive electrode 811 and the display panel 83, and the orthographic projection area of the inductive electrode 811 on the display panel 83 falls into the orthographic projection area of the drive electrode 821 on the display panel 83, the electromagnetic field generated by drive signals in the display panel 83 may be effectively blocked or absorbed by the drive electrode 821, thereby alleviating the influence of the electromagnetic field on the inductive electrode. When the touch display panel is touched, the interference with the inductive electrode 811 by the drive signal may be effectively alleviated, thereby ensuring the touch function of the touch display panel.

In the touch display panel shown in FIG. 9, each of the inductive electrodes 811 may further include a plurality of inductive sub-electrodes 8111 sequentially connected, and each of the drive electrodes 821 may further include a plurality of drive sub-electrodes 8211 sequentially connected. The number of the inductive sub-electrodes 8111 included in one inductive electrode 811 is equal to the number of the drive sub-electrodes 8211 included in one drive electrode 821, and the number of the inductive sub-electrodes 8111 included in the touch display panel is equal to the number of the drive sub-electrodes 8211 included in the touch display panel.

It can be seen in conjunction with FIG. 8 and FIG. 9, for one of the drive sub-electrodes 8211, the number of the inductive sub-electrodes 8111 corresponding to the position of the drive sub-electrode 8211 is one along the orthographic projection direction, and the orthographic projection area of the inductive sub-electrode 8111 on the display panel 83 falls into the orthographic projection area of the drive sub-electrode 8211 corresponding to the position thereof on the display panel 83.

In this way, since the orthographic projection area of each inductive sub-electrode 8111 on the display panel 83 falls into the orthographic projection area of one of the drive sub-electrodes 8211 on the display panel 83, respectively, for each of the drive sub-electrodes 8211, the electromagnetic field generated by the drive signals which interfere with one of the inductive electrodes 8111 may be effectively blocked or absorbed, thereby alleviating the interference with the inductive sub-electrode 8111 by the electromagnetic field. For the entire touch display panel, the interference with the inductive electrode 811 by the drive signal may be effectively alleviated.

In the touch display panel shown in FIG. 9, each of the inductive sub-electrodes 8111 and each of the drive sub-electrodes 8211 have a diamond shape. In other embodiments, each of the inductive sub-electrodes 8111 and each of the drive sub-electrodes 8211 may have a strip shape, or each of the inductive sub-electrodes 8111 has a diamond shape, and each of the drive sub-electrodes 8211 has a strip shape, and the like, which is not specifically limited in the embodiment of the disclosure, as long as the orthographic projection area of the inductive electrode 811 on the display panel 83 falling into the orthographic projection area of the drive electrode 821 on the display panel 83 is satisfied.

In other embodiments of the disclosure, the number of the inductive sub-electrodes 8111 included in at least one inductive electrode 811 of the touch display panel may be greater than the number of the drive sub-electrodes 8211 included in one of the drive electrodes 821, and the orthographic projection area of at least one inductive sub-electrode 8111 on the display panel 83 falls into the orthographic projection area of one of the drive sub-electrodes 8211 on the display panel 83.

FIG. 10 is another top view of the touch display panel shown in FIG. 8. In FIG. 10, the number of the inductive sub-electrodes 8111 included in the inductive electrode 811 is larger than the number of the drive sub-electrodes 8211 included in the drive electrode 821, and the direction perpendicular to the display panel 83 may be an orthogonal projection direction of the inductive electrode 811 on the display panel 83 and an orthogonal projection direction of the drive electrode 821 on the display panel 83.

For the drive sub-electrode 8211 shown in FIG. 10, the number of the inductive sub-electrodes 8111 corresponding to the position of the drive sub-electrode 8211 in the orthogonal projection direction is two, and the orthogonal projection area of the two inductive electrodes 8111 on the display panel 83 falls into the orthographic projection area of the drive sub-electrode 8211 on the display panel 83.

Since the orthographic projection area of every two inductive sub-electrodes 8111 on the display panel 83 falls into the orthographic projection area of one of the drive sub-electrodes 8211 on the display panel 83, for each of the drive sub-electrodes 8211, the electromagnetic field generated by the drive signals which interfere with the two inductive electrodes 8111 may be effectively blocked or absorbed, thereby alleviating the interference with the two inductive sub-electrodes 8111 by the electromagnetic field. For the entire touch display panel, the interference with the inductive electrode 811 by the drive signals may be effectively alleviated.

In another embodiment provided by the disclosure, the second electrically conductive layer in the touch display panel shown in FIG. 8 may further include a plurality of filling blocks.

The plurality of filling blocks fill a gap between the plurality of drive electrodes;

The plurality of filling blocks are insulated from each other, and the plurality of filling blocks and the plurality of drive electrodes are insulated from each other.

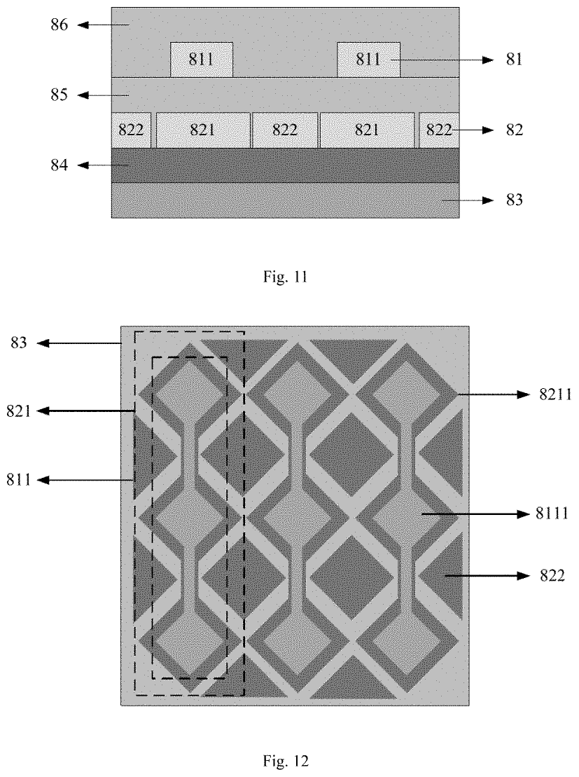

As shown in FIG. 11, as compared with FIG. 8, FIG. 11 may include a plurality of filling blocks 822, the material of the plurality of filling blocks 822 may be the same as that of the drive electrodes 821. FIG. 12 is a top view of the touch display panel as shown in FIG. 11. As can be seen from FIG. 12, for each of the filling blocks 822, it fills the gap between the drive electrodes 821, but is insulated from each of the drive electrodes 821, and the plurality of filling blocks 822 may be insulated from each other.

Since the plurality of filling blocks 822 are electrically conductive and fill the gap between the plurality of drive electrodes 821, the electromagnetic field of drive signals between the gaps of the plurality of drive electrodes 821 may be effectively blocked or absorbed, preventing the electromagnetic field from acting on the inductive electrode 811 by the gaps between the plurality of drive electrodes 821 and interfering with the inductive electrode 811. In other words, after the plurality of filling blocks 822 filling the gap between the plurality of drive electrodes 821, the interference with the inductive electrodes 811 by the electromagnetic field generated by the drive signal may be more effectively alleviated, thereby ensuring the touch function of the touch display panel.

The touch display panel provided by the embodiment of the disclosure includes: a first electrically conductive layer 81, a second electrically conductive layer 82, and a display panel 83, wherein the first electrically conductive layer 81 includes a plurality of inductive electrodes 811; the second electrically conductive layer 82 includes a plurality of a drive electrode 821; and the second electrically conductive layer 82 is located between the first electrically conductive layer 81 and the display panel 83; an orthographic projection area of the plurality of inductive electrodes 811 on the display panel 83 falls into an orthographic projection area of the plurality of drive electrodes 821 on the display panel 83. Thus, since the drive electrode is located between the inductive electrode and the display panel and the orthographic projection area of the inductive electrode on the display panel falls into the orthographic projection area of the drive electrode on the display panel, the electromagnetic field generated by drive signals may be effectively blocked or absorbed by the drive electrode. When the touch display panel is touched, the interference with the inductive electrode by the drive signal may be effectively alleviated, thereby ensuring the touch function of the touch display panel.

### Embodiment 6

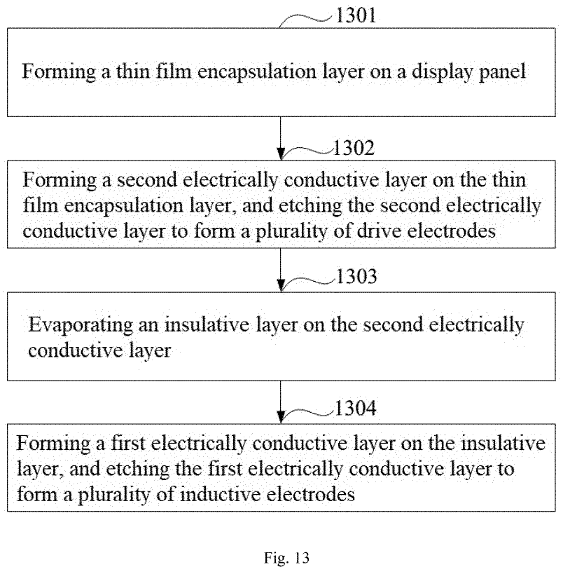

FIG. 13 is a schematic flow chart of a manufacturing method for a touch display panel according to an embodiment of the disclosure. The manufacturing method may be used to manufacture the touch display panel recorded according to Embodiment 5. The manufacturing method is as follows.

Step 1301: Forming an Encapsulation Layer on the Display Panel.

The material for the encapsulation layer may be a material with low dielectric constant which may range from 3 to 8. The material with low dielectric constant may be silicon oxide or silicon oxynitride, or may also be other materials with low dielectric constant.

Thus the inductive capacitance between the cathode and the touch electrode in the touch layer in the display panel may be reduced. When the display panel is touched, the inductive capacitance between the cathode and the inductive electrode and the inductive capacitance between the cathode and the drive electrode are reduced, compared with the prior art, the interference with the touch electrode by the cathode may be reduced, thereby reducing the damage to the touch function of the touch display panel and improving the touch sensitivity of the touch display panel.

In the embodiment of the disclosure, in order to further alleviate interference between the cathode and the touch electrode, the thickness of the encapsulation layer may be between 1 and 10 μm.

Step 1302: Forming a Second Electrically Conductive Layer on the Encapsulation Layer, and Etching the Second Electrically Conductive Layer to Form a Plurality of Drive Electrodes.

In step 1302, when the plurality of drive electrodes are formed, the area of the drive electrodes may be appropriately increased so that an orthogonal projection area of the inductive electrode formed in step 1304 on the display panel falls into an orthographic projection area of the drive electrode on the display panel.

Step 1303: Evaporating an Insulative Layer on the Second Electrically Conductive Layer.

The material for the insulative layer may be a transparent material.

In the embodiment of the disclosure, the insulative layer may adopt a material with high dielectric constant which may be greater than or equal to 30. The material with high dielectric constant may be silicon nitride or titanium oxide, or may also be other materials with high dielectric constant such as alumina, magnesia, zirconia, etc., which are not specifically limited herein.

In this way, the inductive capacitance between the inductive electrode and the drive electrode may be increased. When the touch display panel is touched, owing to the increased inductive capacitance between the inductive electrode and the drive electrode, the interference with the inductive electrode and the drive electrode by the cathode may be alleviated, thereby improving the touch sensitivity of the touch display panel.

In order to further increase the inductive capacitance between the inductive electrode and the drive electrode, the thickness of the insulative layer may also be set between 0.01 and 10 μm.

Step 1404: Forming a First Electrically Conductive Layer on the Insulative Layer, and Etching the First Electrically Conductive Layer to Form a Plurality of Inductive Electrodes.

An orthographic projection area of the manufactured plurality of inductive electrodes on the display panel falls into an orthographic projection area of the plurality of the drive electrodes on the display panel. In this way, the electromagnetic field generated by drive signals may be effectively blocked or absorbed by the plurality of the drive electrode, thereby effectively alleviating the interference with the plurality of the inductive electrode by the drive signals and ensuring the touch function of the touch display panel.

In this embodiment of the disclosure, each of the inductive electrodes may include a plurality of sequentially connected inductive sub-electrodes, and each of the drive electrodes may further include a plurality of sequentially connected drive sub-electrodes,

The number of the inductive sub-electrodes may be equal to the number of the drive sub-electrodes, and an orthographic projection area of each of the inductive sub-electrodes on the display panel may fall into an orthographic projection area of one of the drive sub-electrodes on the display panel, respectively. For details, refer to the touch display panel in FIG. 8 described above, and the description is not repeated herein.

The number of the inductive sub-electrodes may also be greater than the number of the drive sub-electrodes, and an orthographic projection area of at least one inductive sub-electrode on the display panel may fall into an orthographic projection area of one of the drive sub-electrodes on the display panel, respectively. For details, refer to the touch display panel in FIG. 9 and FIG. 10 described above, and the description is not repeated herein.

Each of the inductive sub-electrodes and each of the drive sub-electrodes may have a diamond shape or a strip shape, which is not specifically limited herein.

It should be noted that, in step 1302, when the second electrically conductive layer is etched to form the plurality of drive electrodes, the second electrically conductive layer may also be etched to form a plurality of filling blocks which may fill the gap between the plurality of drive electrodes. The plurality of filling blocks and the plurality of drive electrodes are insulated from each other, and the plurality of filling blocks may be insulated from each other.

In the embodiment of the disclosure, since the plurality of filling blocks obtained by etching the second electrically conductive layer, the electromagnetic field of the drive signals in the gap between the plurality of drive electrodes may be effectively blocked or absorbed by the plurality of filling blocks, preventing the electromagnetic field from acting on the plurality of inductive electrodes by the gaps between the plurality of drive electrodes and interfering with the plurality of inductive electrodes. In this way, the interference with the plurality of inductive electrodes by the electromagnetic field generated by the drive signals may be more effectively alleviated, thereby ensuring the touch function of the touch display panel.

In the touch display panel manufactured by the manufacturing method for the touch display panel provided by the embodiment of the disclosure, since the plurality of drive electrodes are located between the plurality of inductive electrodes and the display panel, and the orthographic projection area of the plurality of inductive electrodes on the display panel falls into the orthographic projection area of the plurality of drive electrodes on the display panel, the electromagnetic field generated by the drive signals may be effectively blocked or absorbed by the drive electrodes. When touching the touch display panel, the interference with the inductive electrode by the drive signal may be effectively alleviated, thereby ensuring the touch function of the touch display panel.

### Embodiment 7

In the embodiment of the disclosure, as for the touch display panel described in the above embodiment 5, the interior of at least one inductive electrode in the touch display panel may also be hollowed out to reduce the relative area between the inductive electrode and the cathode of the touch display panel, thereby reducing the inductive capacitance between the inductive electrode and the cathode.

In this way, when the touch display panel is touched, since the inductive capacitance between the cathode and the touch electrode is reduced, compared with the prior art, the interference with the touch electrode by the cathode may be alleviated, thereby reducing the damage to the touch function of the touch display panel and improving the touch sensitivity of the touch display panel.

For details, please refer to the content described in the embodiment shown in FIG. 3 above, and such description is not repeated here.

### Embodiment 8

In the embodiment of the disclosure, as for the touch display panel of the above embodiment 5, the area in the cathode of the touch display panel corresponding to the position of the touch electrode may be hollowed out, or the area in the cathode corresponding to the overlapping portion between the inductive electrode and the drive electrode may be hollowed out so that the interference with the touch electrode by the cathode may also be alleviated, thereby improving the touch sensitivity of the touch display panel.

In this way, when the touch display panel is touched, since the inductive capacitance between the cathode and the touch electrode is reduced, compared with the prior art, the interference with the touch electrode by the cathode may be alleviated and change in capacitance detected by the inductive electrode may be increased, thereby improving the detection sensitivity of the inductive electrode and further improving the touch sensitivity of the touch display panel.

For details, please refer to the content described in the embodiments shown in FIG. 6 and FIG. 7 above, and such description is not repeated here.

### Embodiment 9

The embodiment of the disclosure provides a touch display device which may include any one of the touch display panels described in the embodiments shown in FIG. 1 to FIG. 12.

A person skilled in the art should understand that although the preferred embodiments of the disclosure have been described, the additional modifications and changes may be made to the embodiments as long as a person skilled in the art knows basic innovative concepts. Therefore, the appended claims are intended to be interpreted as including the preferred embodiments and the modifications and changes falling into the protection scope of the disclosure.

It is apparent that various modifications and changes may be made by a person skilled in the art to the disclosure without departing from the scope of the disclosure. Thus, the disclosure is intended to cover the modifications and changes of the disclosure if the modifications and changes made to the disclosure fall into the protection scope of the claims and the equivalent technology of the disclosure.

1. A touch display panel comprising:
a cathode,
a touch layer, and
an encapsulation layer located between the cathode and the touch layer, a material of the encapsulation layer having a dielectric constant ranging from 3 to 8.

2. The touch display panel according to claim 1, wherein
the encapsulation layer has a thickness of 1 to 10 μm.

3. The touch display panel according to claim 1, wherein
the encapsulation layer comprises at least one of a thin film encapsulation layer and a substrate layer,
and when the encapsulation layer comprises the thin film encapsulation layer and/or the substrate layer, a material of at least one of the thin film encapsulation layer and the substrate layer has a dielectric constant ranging from 3 to 8.

4. The touch display panel according to claim 1,
wherein the touch layer comprises
a first electrically conductive layer and a first insulative layer,
the first electrically conductive layer comprises a plurality of inductive electrodes and a plurality of drive electrodes;
the first insulative layer covers the first electrically conductive layer, and a material of the insulative layer has the dielectric constant equal to or greater than 30.

5. The touch display panel according to claim 4, wherein
the first insulative layer has a thickness of 0.01 to 10 μm.

6. The touch display panel according to claim 1, wherein the touch layer comprises
a second electrically conductive layer, a third electrically conductive layer and a second insulative layer,
the second electrically conductive layer comprises a plurality of inductive electrodes, and the third electrically conductive layer comprises a plurality of drive electrodes;
the second insulative layer is located between the second electrically conductive layer and the third electrically conductive layer, and a material of the second electrically conductive layer has the dielectric constant equal to or greater than 30.

7. The touch display panel according to claim 6, wherein
the second insulative layer has a thickness of 0.01 to 10 μm.

8. The touch display panel of claim 6, further comprising a display panel, wherein:
the touch layer covers the display panel, and the third electrically conductive layer is located between the second electrically conductive layer and the display panel; and
an orthographic projection area of the plurality of inductive electrodes on the display panel falls into an orthographic projection area of the plurality of drive electrodes on the display panel.

9. The touch display panel according claim 8, wherein
each of the drive electrodes comprises a plurality of
sequentially connected drive sub-electrodes and each of the inductive electrodes comprises a plurality of sequentially connected inductive sub-electrodes,
the number of the inductive sub-electrodes is equal to the number of the drive sub-electrodes, and an orthographic projection area of each of the inductive sub-electrodes on the display panel falls into an orthographic projection area of one of the drive sub-electrodes on the display panel, respectively; or
the number of the inductive sub-electrodes is greater than the number of the drive sub-electrodes, and an orthographic projection area of at least one inductive sub-electrode on the display panel falls into an orthographic projection area of one of the drive sub-electrodes on the display panel.

10. The touch display panel of claim 9, wherein the third electrically conductive layer further comprises a plurality of filling blocks, the plurality of filling blocks fill a gap between the plurality of drive electrodes;
the plurality of filling blocks are insulated from each other, and the plurality of filling blocks and the plurality of drive electrodes are insulated from each other.

11. A touch display panel,
comprising a first electrically conductive layer, a second electrically conductive layer, and a display panel,
the first electrically conductive layer comprising a plurality of inductive electrodes, and the second electrically conductive layer comprising a plurality of drive electrodes and being located between the first electrically conductive layer and the display panel;
an orthographic projection area of the plurality of inductive electrodes on the display panel falling into an orthographic projection area of the plurality of drive electrodes on the display panel.

12. The touch display panel according to claim 11, wherein each of the drive electrodes comprises a plurality of sequentially connected drive sub-electrodes,
and each of the inductive electrodes comprises a plurality of sequentially connected inductive sub-electrodes,
the number of the inductive sub-electrodes is equal to the number of the drive sub-electrodes, and an orthographic projection area of each of the inductive sub-electrodes on the display panel falls into an orthographic projection area of one of the drive sub-electrodes on the display panel, respectively; or
the number of the inductive sub-electrodes is greater than the number of the drive sub-electrodes, and an orthographic projection area of at least one inductive sub-electrode on the display panel falls into an orthographic projection area of one of the drive sub-electrodes on the display panel.

13. The touch display panel according to claim 12, wherein
the drive sub-electrode has a diamond shape and/or a strip shape, and the inductive sub-electrode has a diamond shape and/or a strip shape.

14. The touch display panel of claim 11, wherein the second electrically conductive layer further comprises a plurality of filling blocks, the plurality of filling blocks fill a gap between the plurality of drive electrodes;
the plurality of filling blocks are insulated from each other, and the plurality of filling blocks and the plurality of drive electrodes are insulated from each other.

15. The touch display panel according to claim 14, wherein the display panel comprises a drive signal line for providing drive signals comprising at least one of a data voltage signal, a supply power signal, a scan control signal, and a luminescence control signal.

16. The touch display panel according to claim 11, further comprising
a cathode,
the cathode comprises at least one hollow-out area, and the position of each hollow-out area corresponds to the position of one of the inductive electrodes or one of the drive electrodes, respectively.

17. A manufacturing method for
a touch display panel, comprising:
forming an encapsulation layer on the display panel;
forming a second electrically conductive layer on the encapsulation layer, and etching the second electrically conductive layer to form a plurality of drive electrodes;
evaporating an insulative layer on the second electrically conductive layer;
forming a first electrically conductive layer on the insulative layer, and etching the first electrically conductive layer to form a plurality of inductive electrodes; and
making an orthographic projection area of the plurality of inductive electrodes on the display panel fall into an orthographic projection area of the plurality of drive electrodes on the display panel.

18. The manufacturing method according to claim 17, wherein each of the drive electrodes comprises a plurality of sequentially connected drive sub-electrodes,
and each of the inductive electrodes comprises a plurality of sequentially connected inductive sub-electrodes,
the number of the inductive sub-electrodes is equal to the number of the drive sub-electrodes and an orthographic projection area of the inductive sub-electrodes on the display panel falls into an orthographic projection area of one of the drive sub-electrodes on the display panel, respectively; or
the number of the inductive sub-electrodes is greater than the number of the drive sub-electrodes, and an orthographic projection area of at least one inductive sub-electrodes on the display panel falls into an orthographic projection area of one of the drive sub-electrodes on the display panel.

19. The manufacturing method according to claim 17, wherein
a plurality of filling blocks are formed when etching the second electrically conductive layer; the plurality of filling blocks fill a gap between the plurality of drive electrodes; the plurality of filling blocks are insulated from each other; and the plurality of filling blocks and the plurality of drive electrodes are insulated from each other.

20. A touch display device, comprises a touch display panel having a cathode, a touch layer and an encapsulation layer located between the cathode and the touch layer, and a material of the encapsulation layer having a dielectric constant ranging from 3 to 8, or comprises a touch display panel having a first electrically conductive layer, a second electrically conductive layer, and a display panel, the first electrically conductive layer comprising a plurality of inductive electrodes, and the second electrically conductive layer comprising a plurality of drive electrodes and being located between the first electrically conductive layer and the display panel; and an orthographic projection area of the plurality of inductive electrodes on the display panel falling into an orthographic projection area of the plurality of drive electrodes on the display panel.
